(19) United States
(12) Patent Application Publication
(10) Pub. No.: US 2004/0016477 A1
(43) Pub. Date: Jan. 29, 2004

(54) Method for producing a magnetic alloy and apparatus for producing the same

(75) Inventor: Kazuhiko Kuribayashi, Sagamihara City (JP)

Correspondence Address: OLIFF & BERRIDGE, PLC, P.O. BOX 19928, ALEXANDRIA, VA, 22320, US

(73) Assignee: The Institute of Space and Astronautical Science, Sagamihara City (JP)

(21) Appl. No.: 10/396,338

(22) Filed: Mar. 26, 2003

(30) Foreign Application Priority Data
Jul. 8, 2002 (JP) 2002-198,243

(51) Int. Cl. H01F 41/02

(52) U.S. Cl. 148/108

(57) ABSTRACT

A magnetic alloy raw material is heated and melted to create a melt with floating said raw material by means of electromagnetic field from an inductive type heating coil. The melt is located in between a pair of cupper cooling plates driven by a solenoid coil, and then, splat-cooled below the peritectic point of the raw material by the cooling plates.

### BACKGROUND OF THE INVENTION

1. Field of the Invention

This invention relates to a method and an apparatus for producing a magnetic alloy which is preferably usable as a magnetostriction alloy for a small actuator and a low cost-high performance magnet and usable for an ultraminiature thermoelectric conversion element.

2. Related Art

Recently, new types of magnetic material such as a bond magnet and the like have been intensely developed. The new magnetic materials are made in various shapes. Among the new magnetic materials, particularly a Nd₂Fe₁₄B(2-14-1) magnetic alloy has been intensely developed.

Since the (2-14-1) magnetic alloy has a peritectic point, in the production of the magnetic alloy with a melting process and a solidifying process, a primary phase of y-Fe is crystallized at a liquidus temperature of TL and then, a peritectec phase is created at a peritectic point of TP(TL>TP) through the peritectic reaction of primary phase+liquid phase→peritectic phase. In the peritectic reaction, since the solid diffusion in the primary phase is a rate controlling, and the reaction rate of the peritectic reaction is determined on the rate of the solid diffusion. Therefore, the peritectic reaction requires much time of period. In addition, in many cases, since the primary phase remains in the thus obtained (2-14-1) magnetic alloy substantially, the (2-14-1) alloy phase is reduced substantially. As a result, a desired (2-14-1) alloy can not be produced.

In this point of view, such an attempt is made as to heat a (2-14-1) raw material to create a melt, supercool the melt to create an amorphous structure, and produce an intended (2-14-1) magnetic alloy through the crystallization of the amorphous structure. In this case, since the reaction process does not require a peritecric reaction, the producing period of time can be shortened. Moreover, since the primary phase of γ-Fe is not created, the desired (2-14-1) magnetic alloy can be made efficiently without the remaining primary phase.

As the supercooling means, a melt-spin method can be employed. In this case, the (2-14-1) magnetic alloy is made in a ribbon shape or a flake shape. Therefore, the ribbon-shaped or the flake shaped (2-14-1) raw materials are crushed and then, bound with resin to produce the intended bulky (2-14-1) magnetic alloy. In this case, additional processes are required and thus, the total producing process becomes complicated, resulting in the increase of producing cost.

### SUMMERY OF THE INVENTION

It is an object of the present invention to provide a new method and an apparatus easily capable of producing a magnetic alloy with peritectic point such as a (2-14-1) magnetic alloy.

In order to achieve the above object, this invention relates to a method for producing a magnetic alloy, comprising the steps of:

heating and melting a magnetic alloy raw material with a peritectic point to create a melt,

supercooling the melt below the peritectic point of the magnetic alloy raw material so that the temperature of a solid-liquid interface of the melt is set below the peritectic point of the magnetic alloy raw material and the growth rate of a peritectic phase is set larger than the growth rate of a primary phase, and then, solidifying the melt.

This invention also relates to an apparatus for producing a magnetic alloy, comprising:

a heating-melting means to heat and melt a magnetic alloy raw material with a peritectic point to create a melt, and

a cooling means to supercool the melt below the peritectic point of the magnetic alloy raw material so that the temperature of a solid-liquid interface of the melt is set below the peritectic point of the magnetic alloy raw material and the growth rate of a peritectic phase is set larger than the growth rate of a primary phase, and then, solidifying the melt.

The inventor had intensely studied to achieve the above object. As a result, the inventor had found out the following facts. When a magnetic raw material with peritectic point such as a (2-14-1) magnetic raw material is heated to create a melt and then, supercooled and solidified below the peritectic point, if the temperature of the solid-liquid interface is set below the peritectic point and the growth rate of the peritectic phase is set larger than the growth rate of the primary phase, an intended magnetic alloy phase can be crystallized and thus, an intended magnetic alloy can be produced in a given shape almost without the primary phase.

In the present invention, moreover, in the production of the intended magnetic alloy, only the supercooling process is required and other processes such as a peritectic reaction, a crushing process and a binding process are not required. Therefore, the intended magnetic alloy such as the (2-14-1) magnetic alloy can be produced easily in short period of time.

In a preferred embodiment of the present invention, the solidifying process is carried out in the condition that the melt is floated with an electromagnetic field generated through an electromagnetic field-generating means. In this case, uniform nuclear creation can be inhibited in the solidifying process using a given container where the melt is disposed, and thus, the intended magnetic alloy can be made easily.

In another preferred embodiment of the present invention, a splat cooling mechanism is prepared, the melt is splat-cooled rapidly in the solidifying process. In this case, the melt can be supercooled at a higher cooling rate, so that the above-mentioned supercooling condition can be satisfied easily and thus, the intended magnetic alloy can be easily made.

In a further preferred embodiment of the present invention, the splat cooling process is carried out just before the nuclear creation of the primary phase in the melt, concretely within a higher temperature range than the nuclear creation temperature by 10-100° C. In this case, the creation of the primary phase can be inhibited effectively, so that the intended magnetic alloy, wall of which is almost occupied by the intended magnetic alloy phase, can be easily produced.

If the composition of the magnetic alloy raw material is controlled, the nuclear creation temperature of the primary phase can be set below the peritectic point. In this case, the creation of the primary phase can be inhibited and the splat cooling process can be carried out within any temperature range.

In a still further embodiment of the present invention, the melt creating process and the solidifying process are carried out under an inert gas atmosphere. In this case, the splash of the melt can be prevented effectively and electric discharge can be also prevented, to produce the intended magnetic alloy stably.

Other aspects and advantages of the present invention will be apparent from the following description of embodiments with reference to the accompanying drawings.

### BRIEF DESCRIPTION OF THE DRAWINGS

For better understanding of the present invention, reference is made to the attached drawings, wherein

FIG. 1 is a structural view showing an apparatus for producing a magnetic alloy according to the present invention, and

FIG. 2 is a microscopic photograph of a (2-14-1) magnetic alloy produced by the producing method and the producing apparatus of the present invention.

### DESCRIPTION OF THE PREFERRED EMBODIMENTS

This invention will be described in detail with reference to the accompanying drawings.

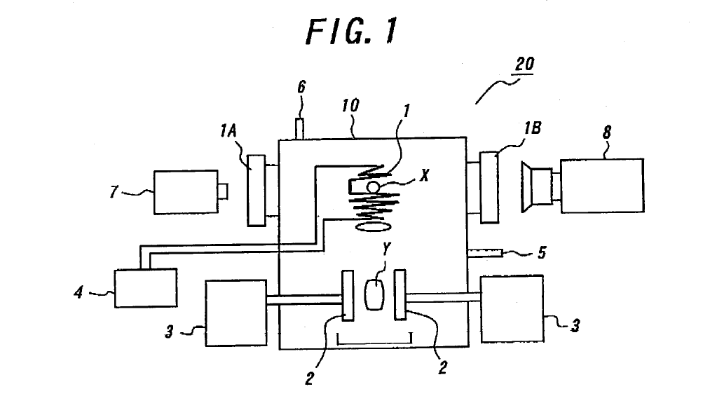

FIG. 1 is a structural view showing an apparatus for producing a magnetic alloy according to the present invention. The producing apparatus 20 illustrated in FIG. 1 includes an inductive type heating coil 1 as a floating means and a heating-melting means, a pair of cooling cupper plates 2 as a splat cooling mechanism, and solenoid coils 3. The coil 1 and the plates 2 are disposed separately in the container 10 so that the coil 1 is located at the center in between the plates 2.

The plates 2 are maintained within a temperature range of 20-100° C. The solenoid coils 3 are disposed backward from the plates 2 outside the container 10.

The inductive type heating coil 1 is connected to a high frequency wave-generating apparatus 4 provided outside the container 10. At the container 10 are provided a gas inlet 5 and a gas outlet 6, through which an inert gas is introduced and exhausted to charge the container 10. A magnetic alloy raw material X is disposed in the interior space of the coil 1. Moreover, outside the container 10 are provided a pyrometer 7 and a high speed video camera 8 which are utilized for monitoring the beating-melting state of the magnetic alloy raw material X via windows 1A and 1B.

When a given high frequency wave is applied to the inductive type heating coil 1 from the high frequency wave-generating apparatus 4, the magnetic alloy raw material X, located in the interior space of the coil 1, is floated and heated to be melted by means of the high frequency wave. The heating state of the magnetic alloy raw material X is monitored with the pyrometer 7 and the high speed video camera 8, and the heating condition such as the output of the high frequency wave is controlled dependent on the heating state. Therefore, the magnetic alloy raw material can be heated in a desired state.

The high frequency wave is shut off, and the thus obtained melt Y from the magnetic alloy raw material X is dropped off and located in between the cooling plates 2 and thus, splat-cooled by plates 2 driven by the solenoid coils 3.

The cooling rate is determined dependent on the amount of the melt Y and the temperature of the plates 2, and concretely set within about 10,000-100,000° C./sec. The melt Y is supercooled below the peritectic point of the magnetic alloy raw material X at a cooling rate within the above range, and then, solidified. In this case, the temperature of the solid-liquid interface of the melt Y becomes below the peritectic point of the magnetic alloy raw material X, and thus, the growth rate of the peritectic phase becomes larger than the growth rate of the primary phase. Therefore, the primary phase does not almost remains in the solidification structure, and thus, all of the solidification structure is almost occupied by an intended magnetic alloy phase. As a result, an intended magnetic alloy can be obtained.

As is apparent from the previous description, the desired magnetic alloy can be produced only by supercooling the melt Y at a given cooling rate within the above-mentioned range without another process. In other words, the intended magnetic alloy can be produced easily in a short period of time without other processes such as a peritectic reaction, a crushing process, and a binding process.

It is desired that the supercooling process for the melt Y with the plates 2 is carried out within a temperature range just before the creation of the primary phase. In this case, the creation of the primary phase can be inhibited effectively, and thus, the intended magnetic alloy can be easily produced where the intended magnetic alloy phase is crystallized. Concretely, the temperature range is set to a higher temperature range than the temperature of the nuclear creation of the primary phase by 10-100° C.

If the composition of the magnetic alloy raw material X is controlled appropriately, the temperature of the nuclear creation of the primary phase can be set below the peritectic point. In this case, the nuclear creation of the primary phase can be inhibited effectively, and the splat-cooling process can be carried out within any range of temperature. Therefore, the degree of freedom for the supercooling process can be enlarged, so that the intended magnetic alloy can be produced easily.

In the producing apparatus 20 illustrated in FIG. 1, since the heating-melting process and the solidifying process are carried out in the condition that the container 10 is charged with the inert gas, the electric discharge in the heating-melting process and the splash of the melt Y in the solidifying process can be prevented effectively.

The present invention can be applied for the production of the magnetic alloy with peritectic point. Concretely, as the magnetic alloy are exemplified an alloy containing Nd, Fe and B such as a (2-14-1) magnetic alloy, and a magnetostriction alloy such as a Sm—Co magnetic alloy, a Sm—Fe magnetic alloy and a Fe-rare earth metal magnetic alloy. In order to prevent the creation of the primary phase effectively, an additive element such as Ti may be contained in the magnetic alloy. Particularly, the present invention can be preferably applied for the alloy containing Nd, Fe and B which is intensely researched and developed recently.

In the production of the alloy containing Nd, Fe and B, the primary phase of γ-Fe is crystallized in the supercooling process and the solidification process. In order to prevent the creation of the primary phase effectively, therefore, the above-mentioned splat-cooling process is carried out within a temperature range just before the temperature of the nuclear creation of the γ-Fe, concretely within a higher temperature range than the temperature of the nuclear creation by 10-100° C. In addition, as mentioned above, if the additive element such as Ti is added into the melt, the temperature of the nuclear creation can be set below the peritectic point to prevent the creation of the γ-Fe.

### EXAMPLE

In this Example, a (2-14-1) magnetic alloy as an alloy containing Nd, Fe and B was produced by utilizing a producing apparatus as shown in FIG. 1. A (2-14-1) magnetic raw material was heated and melted in the same manner as mentioned above, and the thus obtained melt was splat-cooled at a temperature of 1280° C. higher than the nuclear creation temperature of 1250° C. of the primary phase or γ-Fe by 30° C. In this case, the cooling plates 2 were set to 25° C. and the cooling rate was set to about 50,000° C./sec,

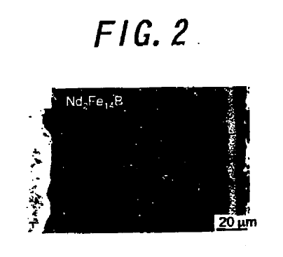

FIG. 2 is a microscopic photograph of the thus obtained (2-14-1) magnetic alloy. As is apparent from FIG. 2, it is turned out that the primary phase, γ-Fe does not almost remains in the magnetic alloy, and all of the magnetic alloy is occupied by the intended (2-14-1) magnetic alloy phase. Moreover, it was turned out that a Nd_{7.8}Fe₈₄B_{8.2} magnetic alloy and a Nd₈Fe₈₂B_{8.1}Ti_{1.9} magnetic alloy were produced in the same manner as mentioned above.

Although the present invention was described in detail with reference to the above examples, this invention is not limited to the above disclosure and every kind of variation and modification may be made without departing from the scope of the present invention.

As mentioned above, according to the present invention, a new method and an apparatus easily capable of producing a magnetic alloy with peritectic point such as a (2-14-1) magnetic alloy can be provided.

What is claimed is:

1. A method for producing a magnetic alloy, comprising the steps of:
heating and melting a magnetic alloy raw material with a peritectic point to create a melt,
supercooling said melt below said peritectic point of said magnetic alloy raw material so that a temperature of a solid-liquid interface of said melt is set below said peritectic point of said magnetic alloy raw material and a growth rate of a peritectic phase is set larger than a growth rate of a primary phase, and then, solidifying said melt.

2. The producing method as defined in claim 1, wherein said melt is supercooled and solidified with floated in air by means of electromagnetic field.

3. The producing method as defined in claim 1, wherein said melt is supercooled and solidified by means of splat cooling.

4. The producing method as defined in claim 3, wherein said splat cooling is carried out within a temperature range just before the nuclear creation of said primary phase.

5. The producing method as defined in claim 4, wherein said splat cooling is carried out within a higher temperature range than a temperature of the nuclear creation of said primary phase by 10-100° C.

6. The producing method as defined in claim 3, wherein a temperature of the nuclear creation of said primary phase is set below said peritectic point of said magnetic alloy raw material by controlling the composition of said magnetic alloy raw material.

7. The producing method as defined in claim 1, wherein said magnetic alloy raw material contains Nd, Fe and B.

8. The producing method as defined in claim 7, wherein said melt is supercooled from a temperature range just before the nuclear creation of γ-Fe as said primary phase.

9. The producing method as defined in claim 7, wherein a temperature of the nuclear creation of γ-Fe as said primary phase is set below said peritectic point of said magnetic alloy raw material.

10. The producing method as defined in claim 1, wherein said melt is created, supercooled and solidified under an inert gas atmosphere.

11. An apparatus for producing a magnetic alloy, comprising:
a heating-melting means to heat and melt a magnetic alloy raw material with a peritectic point to create a melt, and
a cooling means to supercool said melt below said peritectic point of said magnetic alloy raw material so that a temperature of a solid-liquid interface of said melt is set below said peritectic point of said magnetic alloy raw material and a growth rate of a peritectic phase is set larger than a growth rate of a primary phase, and then, solidifying said melt.

12. The producing apparatus as defined in claim 11, wherein said cooling means includes a splat cooling mechanism.

13. The producing apparatus as defined in claim 11, further comprising an electromagnetic field-generating means to float said melt in air by means of electromagnetic field.

14. The producing apparatus as defined in claim 11, wherein said heating-melting means and said cooling means are disposed in a given container, further comprising an inert gas-introducing means to introduce an inert gas into said container.
